(19) United States
(12) Patent Application Publication
(10) Pub. No.: US 2004/0244909 A1
(43) Pub. Date: Dec. 9, 2004

(54) Activatable adhesive webs and articles made therefrom

(76) Inventors: David E. Rhodes, Hartsville, SC (US); Arnold B. Floyd JR., Hartsville, SC (US); Gerald L. Lane JR., Hartsville, SC (US); Krishnaraju Varadarajan, Florence, SC (US)

Correspondence Address: Steven A. Nash, DRINKER BIDDLE & REATH LLP, One Logan Square, 18th & Cherry Streets, Philadelphia, PA, 19103-6996, US

(21) Appl. No.: 10/684,356

(22) Filed: Oct. 10, 2003

Related U.S. Application Data
(60) Provisional application No. 60/417,730, filed on Oct. 10, 2002.

(51) Int. Cl. C09J 1/00

(52) U.S. Cl. 156/325

(57) ABSTRACT

The present invention relates to activatable webs having fibrous substrates coated with activatable adhesive and methods of forming the webs into articles by indirectly activating the adhesive using microwave energy. The activatable web may further include a protective coating of a material that is compatible with the adhesive. One or more activatable webs can be formed into the shape of an article such as by wrapping the activatable webs around a mandrel. The activatable webs can be subjected to microwave energy shortly before being formed into the shape of the article or while they are held in the appropriate shape. The microwave energy is absorbed by moisture retained within the fibrous substrate, which becomes heated. The heated moisture activates the adhesive, causing it to bond to any webs in which the activatable web has been brought into contact and to stiffen.

### CROSS-REFERENCE TO RELATED APPLICATION

The present application claims priority from U.S. Provisional Patent Application No. 60/417,730, filed Oct. 10, 2002, which is incorporated herein by reference in its entirety.

### FIELD OF THE INVENTION

The invention relates to activatable adhesives and to methods of making articles from adhesive webs by indirectly activating the adhesive with microwave energy.

### BACKGROUND OF THE INVENTION

It is known to form a variety of articles from paper substrates by forming layers of paper into the shape of the desired article and bonding the layers with adhesive. For example, cylindrical tubes and cores can be manufactured by spiral winding webs of substrates to form the cores. These cores are used in applications ranging from lightweights paper towel cores to cores designed for carrying thousands of pounds of paper, film, and other media. The latter cores must be strong enough to withstand severe stresses and strains resulting from the sheer weight of the products. The cores must also hold up under enormous forces caused by expansion and contraction of the materials wound thereon. Cores that store elastomeric and similar products must be capable of withstanding strong hoop stresses induced by the media.

The adhesives used to bond layers of the spirally wound substrates are integral to the strength of the cores. Water based adhesives, which are most commonly used to bond adjacent layers of paper-based substrates together, introduce weakness and instability into the cores. This weakness and instability is caused by the additional moisture added to the core.

To avoid these problems with water based adhesives, heating a core to activate non-aqueous or low water content adhesives has been tried with some success. Unfortunately, most heat sources penetrate the core unevenly, which results in different adhesive properties for the outer areas of the core compared with the inner areas.

Hot melt adhesives have been used, but are problematic because such adhesives are expensive, flexible, and result in low production speeds. Sodium silicate has also been used as an adhesive, but primarily in its aqueous form, in which it has very low tack, short open-time, and is thin and penetrating. U.S. Pat. No. 3,926,657 to McConnell, which is incorporated herein by reference, describes a method of making a spiral tube using a solution of sodium silicate with calcium carbonate added thereto. Attempts have also been made to use sodium silicate in a dry form. U.S. Pat. No. 3,616,194 to Russell, which is incorporated herein by reference, describes such an attempt. However, the known methods of activating the dry adhesive involve directly heating the silicate, which can result in inconsistent bonding and can scorch or otherwise damage the article as it is formed. Therefore, a method of producing cores and other articles with better strength and uniform adhesion throughout is needed.

Another challenge related to the use of sodium silicate adhesive in a dry form is that if the dry silicate is exposed to ambient conditions for significant periods of time, a white powder can develop on the surface of the adhesive. The powder has been identified as sodium carbonate and is believed to be formed by a reaction between carbon dioxide in the air and the sodium silicate. The powder on the surface tends to inhibit the ability of the silicate to bond once activated. If the dry adhesive is stored for too long, the bonding ability of the silicate can be significantly impaired. Thus, there is also a need for a way of preserving the dry adhesive to provide an enhanced storage life.

### SUMMARY OF THE INVENTION

The present invention relates to activatable webs having a fibrous substrate coated with activatable adhesive and methods of forming the webs into articles by indirectly activating the adhesive using microwave energy. The activatable webs can be prepared and then stored in a dry, inactive state. When desired, one or more activatable webs can be formed into the shape of an article such as by wrapping the activatable webs around a mandrel. The activatable webs can be subjected to microwave energy shortly before being formed into the shape of the article or while they are held in the appropriate shape. The microwave energy is absorbed by moisture retained within the fibrous substrate, which becomes heated. The heated moisture activates the adhesive, causing it to bond to any webs in which the activatable web has been brought into contact and to stiffen.

In another respect, the invention relates to a method of preserving a sodium silicate activatable adhesive. If an activatable web is formed from sodium silicate adhesive coated on a fibrous substrate, the adhesive can be provided with a protective coating of a material that is compatible with the silicate. The protective coating can prevent the formation of sodium carbonate on the surface of the coating by inhibiting the reaction between the silicate and carbon dioxide in the air. The coating is compatible with the silicate so that when activated, the silicate's ability to form a strong bond with an adjecent web is not adversely affected.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

FIG. 1 is a perspective view of a preferred method of forming a core according to the present invention.

FIG. 2 is a perspective view of an alternative embodiment of a method of forming a core according to the invention.

FIG. 3 is a cross-section taken through the line 3-3 in FIG. 1.

FIG. 4 is a partial cross-section of the core only through the line 4-4 in FIG. 1.

FIG. 5 is a cross-section of the core showing an embodiment of microwave energy applied to the core.

FIG. 6 is a cross-section of the core showing an alternative embodiment of microwave energy applied to the core.

FIG. 7 is a cross-sectional schematic view of an activatable web with a protective coating according to the present invention.

### DETAILED DESCRIPTION OF THE DRAWINGS

The present invention relates to a method of forming articles using one or more activatable webs formed from a fibrous substrate that has been coated with an activatable adhesive. The adhesive can be used to bond layers of fibrous materials together, or can be coated on an outside surface of an article as a reinforcing agent.

The substrate should be fibrous so that it can retain moisture. The fibrous substrate can be formed from most any fiber, including natural fibers, such as cellulose in paper, synthetic fibers, glass fibers and metal fibers. For most applications, the preferred fibrous substrate is kraft paper.

The adhesive is a material that can be coated onto the fibrous substrate, dried or cooled to take on a non-tacky, inactive state, and subsequently indirectly activated by microwave energy. A preferred adhesive is a silicate, such as sodium silicate having a ratio of Na₂O to SiO₂ of between 1:1 and 1:4. The silicate can be applied in aqueous form as a wet slurry and dried to take on the inactive state. The adhesive can be applied to one or both sides of the substrate.

It is preferred that a dielectric reducing agent be added to the sodium silicate prior to coating it onto the substrate to avoid the possibilities of uneven heating or scorching during activation. By dielectric reducing agent, what is meant is a material that is compatible with the silicate and decreases the dielectric properties of the silicate, thereby reducing the ability of the silicate to absorb microwave energy and convert it to heat. Preferred dielectric reducing agents are sugars, such as sucrose (cane sugar), dextrose or maltose. The weight ratio of sugar to sodium silicate can be between 5 parts sugar to 95 parts sodium silicate and 35 parts sugar to 65 parts sodium silicate. The dielectric reducing agent prevents the silicate from heating too rapidly when exposed to microwave energy. Sodium silicate with a dielectric reducing agent has many advantages over other adhesives. Once activated, the silicate adhesive is water-resistant, environmentally friendly, non-toxic, inflammable, odorless, and resistant to oil, grease, and microbial activity.

Once coated onto the substrate, the silicate can be heated to drive off moisture so that the silicate takes on a dry, non-tacky state. This state will be referred to as the non-activated state. It is preferred that the combined substrate and coated silicate be dried to a moisture content of between 1 and 15 percent, most preferably between about 6 to 8 percent. After the silicate-coated substrate has been adequately dried, an activatable web has been formed. The term activatable web refers to a fibrous substrate that is coated with an activatable adhesive in the non-activated state. The activatable web can be wound onto a take-up roll for storage or shipment to an off-site plant. If too much moisture is permitted to remain in the combined substrate and coating, blocking can occur because the silicate could activate while tightly wound in the take-up roll. Conditions of excessive humidity and temperature should be avoided when storing the roll to minimize the chance of the silicate activating.

When an article is to be formed from the activatable web, the roll or rolls can be shipped to an appropriate production plant. Articles can, of course, be formed on site as well, if appropriate production equipment is present. A variety of articles can be formed from one or more activatable webs. The webs can be formed into the shape of an article and then activated. Alternatively, the adhesive can be activated prior to forming the webs into the shape of the article.

The adhesive is activated indirectly by the microwave energy. The dielectric reducing agent in the sodium silicate coating reduces the ability of the coating to absorb microwaves directly. Instead, the microwave energy is predominantly absorbed by moisture retained within the fibrous substrate. The moisture becomes excited by the microwave energy and becomes heated, preferably to a temperature within the range of about 82 degrees C. to about 100 degrees C. Some of the heated moisture is driven into contact with the sodium silicate coating, which solubilizes in the heated moisture. The heat and moisture solubilize the sodium silicate by making it more soluble and at least partially dissolving the silicate, which activates and can rapidly bond the adjacent webs. The activated adhesive sets in a substantially rigid, glassy state.

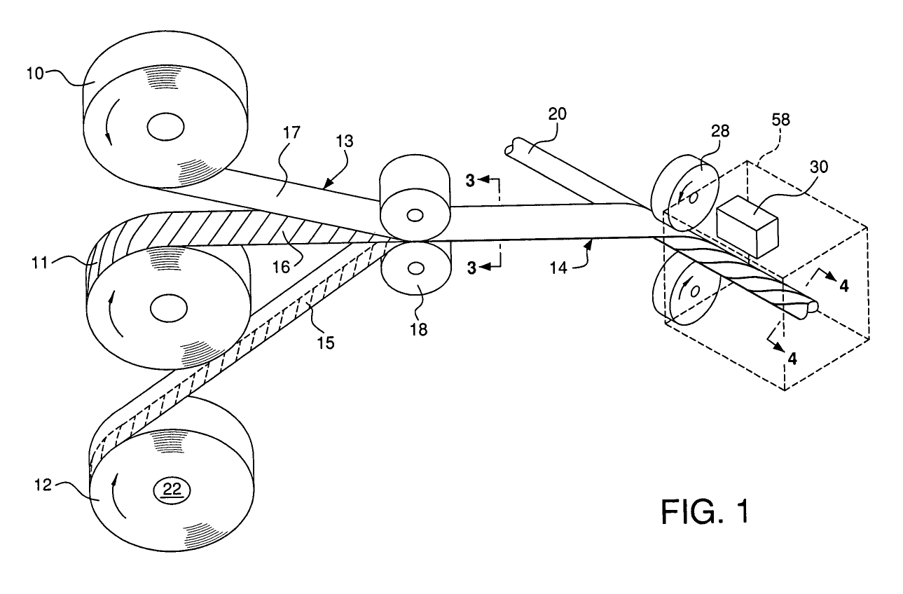

FIG. 1 shows a preferred method of forming an article according to the present invention. The embodiment of FIG. 1 is used to form a core. Three substrate rolls 10, 11, and 12 make up the hybrid web 14 that forms the core 40. An outer roll with no adhesive 10, forms the outer surface of the core 40. An inner roll 12 has a non-activated adhesive applied to only a portion of its inner surface 15 (the surface facing the roll's core 22). The inner roll 12 forms the inner surface of the core. The inner roll's non-activated adhesive 15 is shown on approximately half of the roll. A roll 11 of activatable web with non-activated adhesive 16 applied to its top and bottom side is wound between the inner roll 12 and outer roll 10. If desired, outer roll 10 and middle roll 11 can instead each have non-activated adhesive applied only to the bottom side. (In the case of outer roll 10, the bottom side is that which faces away from the roll's core as shown in FIG. 1, while the bottom surface of roll 11 faces toward the roll's core.)

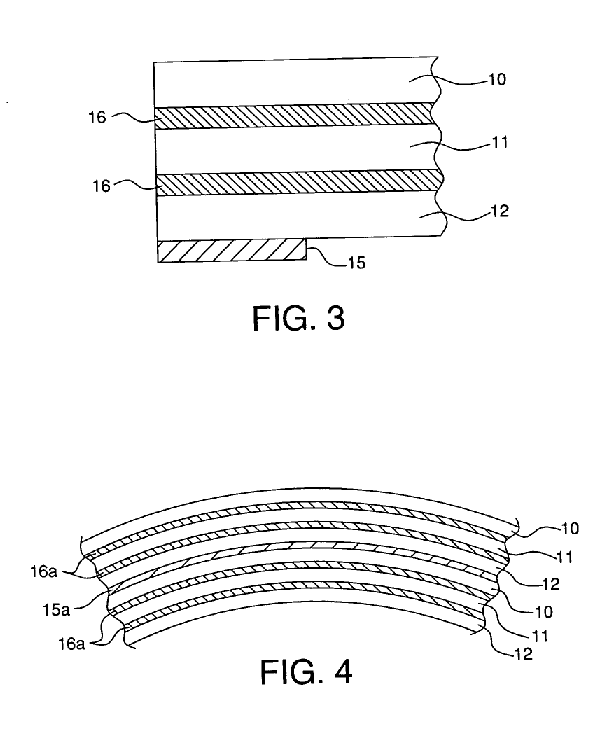

The three layers are shown drawn together by rollers 18 into one hybrid web 14 of all three rolls 10, 11, and 12. FIG. 3 shows a cross section of the hybrid web. This hybrid web 14 is wound onto a mandrel 20. Mandrel rollers 28 wind the hybrid web tightly around the mandrel 20 (the mandrel, in most circumstances is actually turned by a belt that is not shown). As the hybrid web is wound around the mandrel 20, the mandrel 20 and core 40 move in direction A, so that each turn of the mandrel lengthens the core 40. When the hybrid web 14 is wound around the mandrel 20, the hybrid web 14 overlaps itself, and the non-activated adhesive 15 contacts the outer layer 17 of the substrate wound from the outer roll 10.

Once the hybrid web is wound on the mandrel 20, the microwave source 40 is applied to the core within an activation chamber 58. The microwave source indirectly activates the previously non-activated adhesives 15 and 16, and bonds them to the substrate webs 11, 12, and 13. This forms the adhesively joined hybrid web of substrates that forms the core's one-piece structure.

FIG. 4 shows a partial cross section of the core with the layers of the hybrid web wound onto one another. In the Figure, the activated adhesives 15a and 16a have bonded to the rolled layers 10, 11, and 12 to form the core.

The portion of the mandrel 20 that is within the microwave activation chamber 58 is preferably formed from a material that is substantially microwave invisible. Materials that may be appropriate for making such a mandrel include ceramic, quartz, polypropylene, teflon and high density polyethylene. The portion of the mandrel that is not within the microwave chamber can be formed from materials conventionally used for mandrels, such as steel. It is preferred that steel portions of the mandrel be located where stress on the mandrel is greatest, generally between the winding belt and the point of web winding at rollers 28. Therefore, the length of the mandrel that is formed from microwave invisible material in this high stress region should be as short as possible.

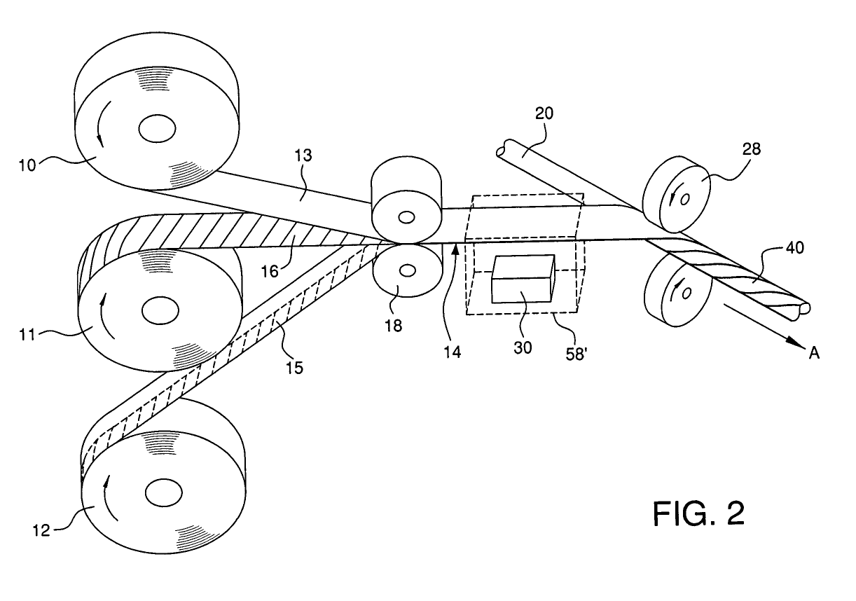

In an alternative embodiment shown in FIG. 2, the activation of the adhesive is done in activation chamber 58′ prior to winding the hybrid web 14 on the mandrel 20. Once the adhesive is activated, it is quickly wound onto the mandrel where it sets and bonds together the spirally wound hybrid web into one core. Where the microwave energy is applied prior to winding the web onto the mandrel, the entire mandrel can be formed from a conventional material. The activation window for sodium silicate adhesive has been found to be between one and three seconds at 75 kilowatts (kW).

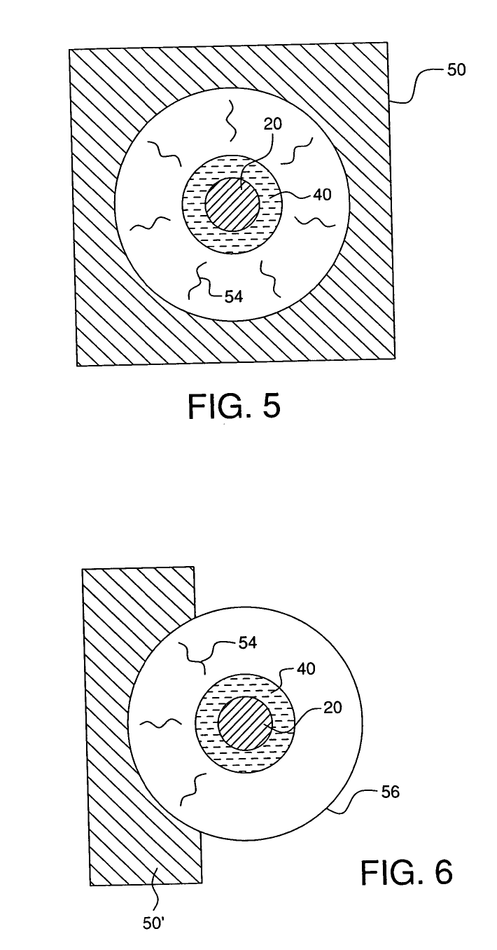

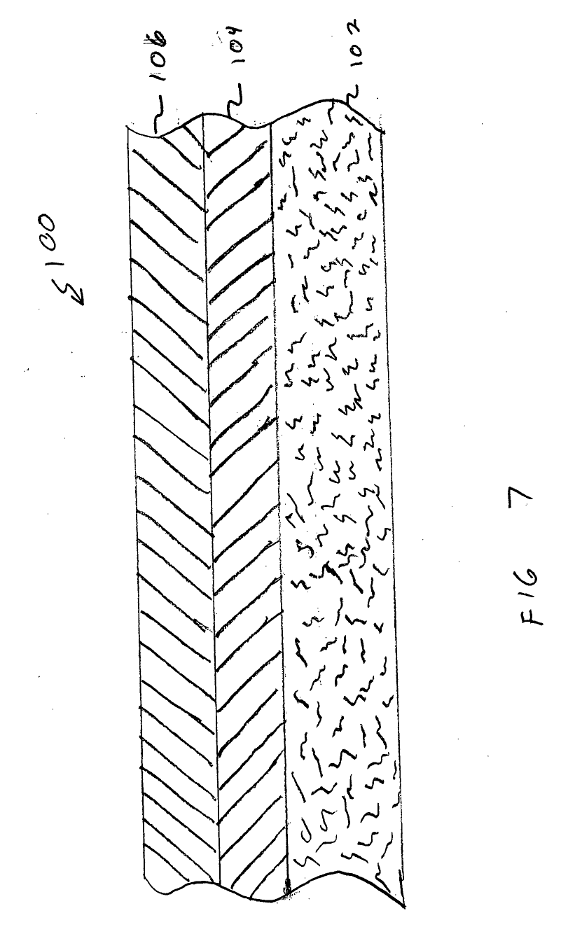

FIGS. 5-6 show cross-sectional embodiments for applying microwave energy to the core 40 on the mandrel 20. FIG. 5 shows the core 40 within a microwave generator 50. The microwave generator completely encircles the core and mandrel, emitting microwave energy 54 evenly through the core, which indirectly activates the adhesive. FIG. 6 shows an alternative embodiment where the microwave generator 50′ is located to one side of the mandrel 20 and emits microwave energy 54 that is contained within the microwave shield 56 of the activation chamber. The shield prevents microwaves from escaping and causing danger to persons working near the mandrel.

Although adhesive roll 11 is shown with adhesive applied to both sides of it, and outer roll 10 has no adhesive applied to it, other combinations of adhesive application can be used to form a core with the desired uniform strength characteristics. For example, it has already been noted that adhesive rolls 10 and 11 can each be of an activatable web with adhesive on the bottom side.

The activatable webs of the present invention can also be used to make convolute and parallel tubes. Such products can be made from paper, cloth or fiberglass or combinations of these materials. The methods disclosed herein can be used to produce products with improved stiffness, dimensional stability and straightness over known tubes.

In addition to cores and tubes, the present invention can be used to form many other articles as well. Activatable webs can be formed into non-round shapes and microwave energy applied shortly before or after the webs are formed into the desired shapes to activate the adhesive. The webs may be formed into such shapes using non-round mandrels, such as those described in the above-noted Russell patent.

Activatable webs can also be used for laminating corrugated medium at high speeds. Such laminated materials can have improved strength and stiffness over those produced by prior lamination methods.

In addition to the bonding ability of the activatable adhesive, it also can be used as a reinforcing agent. In this regard, activatable webs can be in the form of two and three dimensional structures for use in packaging and the like. Webs can be formed into appropriate shapes for use as partitions for boxes or panels for construction of larger articles, such as tables or doors. When so used, the activatable adhesive can be on the outside surface of an article and does not necessarily bond adjacent webs. Instead, the application utilizes the stiffening characteristics of the adhesive. Once the adhesive has been activated, it acts as a reinforcing agent, becoming stiff and adding strength to the article. The activated silicate can also be used to improve surface properties.

An example of an activatable adhesive was prepared by mixing ten parts by weight cane sugar as a dielectric reducing agent with ninety parts sodium silicate. The mixture was applied to paper and air dried to produce an effective activatable adhesive. A test sample was made by clamping two one-inch squares of paper together with a glue line of the adhesive therebetween. The sample was then exposed to microwave energy at 1,200 watts for two minutes to heat the moisture remaining in the paper and indirectly activate the silicate. A fiber tear test revealed a 100 percent fiber-tearing bond. As a comparative example, the same test was conducted using sodium silicate without a dielectric reducing agent. The result of the comparative test was a zero percent fiber-tearing bond.

It should be clear that the methods described herein permit activatable webs to be prepared and stored in rolls or otherwise stored for later use in producing articles. However, it has been found that a sodium silicate coated substrate, when exposed to air for long periods of time, can be adversely affected because the bonding properties of the silicate tend to degrade over time. This is believed to be due to a reaction between carbon dioxide in the air and sodium silicate, which forms sodium carbonate and can appear as a white powder on the surface of the inactive adhesive. The presence of sodium carbonate on the surface inhibits bond formation when the silicate is activated. Consequently, the ability of the silicate-coated web to bond to a second web of material can become degraded. The temperature, concentration of carbon dioxide and other environmental conditions will effect the rate at which the degradation occurs. However, in general, the longer the web is held in storage, the further the degradation progresses.

It has been found that the problem of bonding degradation can be alleviated by providing a compatible protective coating over the sodium silicate before the silicate-coated substrate is stored. FIG. 7 is a schematic cross-sectional representation of an activatable web 100 with a protective coating. The activatable web 100 is formed from a fibrous substrate 102 coated with a sodium silicate adhesive 104 in the non-activated state. The protective coating 106 is applied on top of the sodium silicate adhesive 104. The compatible coating can be a plasticizer of silicate or can be soluble in sodium silicate solution. In order for a material to be considered to be compatible with silicate, the material should be able to solubilize with the silicate or melt under the conditions for activating the silicate. Such compatible materials include sugar, sorbitol, glycerin, ethylene glycol and acrylics. A preferred protective coating is acrylic resin.

The protective coating can be applied to the silicate-coated substrate after the silicate has been dried. The protective coating can be applied as an aqueous solution or by other appropriate means. Once applied, the protective coating substantially prevents the sodium silicate adhesive from reacting with carbon dioxide while in storage. The activatable web 100 can retain its activatable characteristics over longer periods of storage than can a silicate-coated substrate without a protective coating.

An activatable web with a protective coating can be activated with microwave radiation in a similar manner as those without a protective coating. The substrate is formed into the shape of an article, such as by winding around a mandrel, and microwave energy can be applied. The microwave energy is absorbed by moisture in the fibrous substrate, which solubilizes the silicate coating. Because the protective coating is compatible with the silicate, it will also dissolve in the heated moisture, thereby allowing the silicate to bond with another web of material into which the activatable web is brought into contact.

It is possible to use activatable adhesives other than sodium silicate for appropriate applications described above. Alternative adhesives useful in some of the methods of the present invention can include thermoplastic resins, such as polyvinyl acetate (PVAc) or polyethylene (PE), particularly low density (LDPE) or linear low density (LLDPE) polyethylene. Such alternative adhesives can be applied to a fibrous substrate by extrusion coating or the like. When using thermoplastic materials as the activatable adhesive, activation can be achieved by heating the moisture in the fibrous substrate to a degree sufficient to melt the adhesive. Where LDPE or LLDPE are used as the activatable adhesive, the appropriate melting temperature is typically greater than 108 degrees C. To avoid any potential problems associated with moisture boiling within the substrate or bonding zone, PVAc, which can be softened below 100 degrees C., is the preferred thermoplastic adhesive. An appropriate activation window for PVAc activatable adhesive has been found to be between one and eight seconds at 75 kW.

A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. A method of forming articles from fibrous webs, the method comprising the steps of:
providing a wet slurry of sodium silicate;
adding a dielectric reducing agent to the sodium silicate;
coating the wet slurry onto a fibrous substrate;
drying the coated substrate to reduce the total moisture content of the combined substrate and coating to form an activatable web having an activatable adhesive in a non-activated state;
forming the activatable web into the shape of an article; and
heating moisture retained within the fibrous substrate by exposing the substrate to microwave energy to indirectly activate the adhesive by solubilizing the adhesive.

2. The method of claim 1 wherein the drying step comprises the step of reducing the total moisture content of the combined substrate and coating to between 1 and 15 percent.

3. The method of claim 2 wherein the drying step comprises the step of reducing the total moisture content to between 6 and 8 percent.

4. The method of claim 1 wherein the step of adding a dielectric reducing agent comprises adding sugar to the sodium silicate in a weight ratio of between 5 parts sugar to 95 parts silicate and 35 parts sugar to 65 parts silicate.

5. The method of claim 1 wherein the step of forming the activatable web into the shape of an article comprises the step of winding the coated substrate around a mandrel.

6. The method of claim 5 wherein the step of winding the activatable web around a mandrel comprises overlapping layers of the substrate to form a tube.

7. The method of claim 1 wherein the step of forming the activatable web into the shape of an article comprises the step of winding the coated substrate around a mandrel comprising a substantially microwave invisible material.

8. The method of claim 1 wherein the forming step comprises the steps of:
placing the activatable web on an unwind stand to become an outer substrate;
providing an inner substrate on a second unwind stand;
pressing the inner substrate and outer substrate together into a hybrid web, wherein the activatable adhesive is positioned between the inner substrate and the outer substrate; and
winding the hybrid web onto a cylindrical mandrel.

9. The method of claim 1 further comprising the step of applying a protective coating on the activatable adhesive after the drying step.

10. A method for creating a hollow cylindrical core, the method comprising the steps of:
a) providing an outer substrate, the outer substrate being drawn from a first roll;
b) providing an inner substrate, the inner substrate being drawn from a second roll;
c) applying a non-activated adhesive to at least one surface of one of the substrates;
d) pressing the inner substrate and outer substrate together into a hybrid web, wherein the non-activated adhesive is positioned between the inner material and the outer material;
e) winding the hybrid web onto a cylindrical mandrel; and
f) indirectly activating the adhesive by applying microwave energy to heat moisture within at least one of the substrates, wherein the adhesive joins the inner substrate and outer substrate together.

11. The method of claim 10 further comprising the step of applying pressure to the hybrid web after the adhesive activation step.

12. The method of claim 10 wherein the adhesive comprises a sodium silicate and a dielectric reducing agent.

13. The method of claim 12 wherein the dielectric reducing agent is a sugar.

14. The method of claim 13 wherein the weight ratio of sugar to silicate is between 5 parts sugar to 95 parts silicate and 35 parts sugar to 65 parts silicate.

15. The method of claim 10 wherein the adhesive comprises a thermoplastic.

16. A hollow cylindrical core comprising:
a) an outer substrate;
b) an inner substrate;
c) an activated adhesive between the substrate layers, the activated adhesive joining the outer substrate and the inner substrate together to form an adhesively joined hybrid web;
d) wherein the adhesively joined hybrid web is wound upon itself to form the cylindrical core.

17. The core of claim 16 wherein the adhesive comprises a silicate and a dielectric reducing agent.

18. An activatable web for forming articles, the web comprising:
a fibrous substrate having a moisture content;
a coating of a non-activated adhesive that can be indirectly activated by microwave energy absorbed by the moisture in the substrate, the adhesive coating being disposed on the substrate; and
a protective coating of a material that is compatible with the non-activated adhesive, the protective coating being disposed on the adhesive coating.

19. The activatable web of claim 18 wherein the non-activated adhesive comprises sodium silicate.

20. The activatable web of claim 19 wherein the non-activated adhesive further comprises a dielectric reducing agent.

21. The activatable web of claim 18 wherein the compatible material is selected from the group consisting of sugar, sorbitol, glycerin, ethylene glycol and acrylics.

22. The activatable web of claim 18 wherein the compatible material is sucrose.
